(19) United States
(12) Patent Application Publication
(10) Pub. No.: US 2022/0312757 A1
(43) Pub. Date: Oct. 6, 2022

(54) Multi-Spectral Plant Treatment

(71) Applicant: Allen Richard Geiger, Las Cruces, NM (US)

(72) Inventor: Allen Richard Geiger, Las Cruces, NM (US)

(73) Assignee: Darrin Blaine, Las Cruces, NM (US)

(21) Appl. No.: 17/300,798

(22) PCT Filed: May 14, 2020
(86) PCT No.: PCT/US2020/032979

§ 371 Date: Nov. 15, 2021

Related U.S. Application Data
(60) Provisional application No. 62/847,386, filed on May 14, 2019.

(51) Int. Cl. A01M 21/04; G05B 19/4155

(52) U.S. Cl. CPC A01M 21/043; G05B 19/4155; G05B 2219/45013

(57) ABSTRACT

A multi-spectral optical plant treatment device (10) employs a vegetation scanner (20), an electromagnetic radiator (30) and a plant treatment controller (40) for multi-spectral plant treatment applications. In operation, the plant treatment controller (40) executes a discriminating recognition between unwanted plants and wanted plants, and further executes a systematic herbicide EM radiation emission for damaging a recognized unwanted plant in accordance with a photosynthesis termination and/or a photomorphogenesis termination and/or a systematic fertilizer EM radiation emission enhancing a recognized wanted plant in accordance with a plant protection enhancement and/or a plant flavor enhancement.

### FIELD OF THE INVENTION

The present disclosure generally relates to herbicides for damaging plants (e.g., weeds) and to fertilizers for enhancing plants (e.g., crops). The present disclosure specifically relates to utilization of multi-spectral optical herbicide applications for emitting electro-magnetic radiation to damage plants and multi-spectral optical fertilizer applications for emitting electromagnetic radiation to enhance plants.

### BACKGROUND OF THE INVENTION

The physiology of plants is controlled by electro-magnetic (EM) radiation ranging from ultraviolet (UV) light through visible light to near-infrared (IR) light.

For example, photomorphogenesis is a process involving a light interaction with specialized proteins of the plants that controls various aspects of plant development including sugar production for metabolization and protein enhancement for growth and germination.

By further example, photosynthesis is a process involving a light interaction with molecules of the plants that controls a conversion of the light energy into chemical energy.

Historically, a damaging/elimination of unwanted plants in vegetation (e.g., weeds) involves a physical disruption to the physiology of plants (e.g., hoeing and/or cultivation), a chemical disruption to the physiology of plants (e.g., chemical herbicides) and/or a hydration disruption to the physiology of plants (e.g., direct steam or laser heating of water in the plants). These disruptions may experience limitations, such as, for example, costs, environmental issues and non-specific/challenging applications. Consequently, optical herbicides have been proposed to address such limitations of these historical disruptions to the physiology of plants.

For example, U.S. Pat. No. 6,796,568 B1 to Christensen et al. entitled “Method And an Apparatus for Severing Or Damaging Unwanted Plants,” herein incorporated by reference and referred to as the “Christensen Patent,” proposed employing (1) a photosensitive array to identify unwanted plants from wanted plants (i.e., unwanted plant recognition) and (2) a laser source to eliminate the unwanted plants (i.e., EM radiation emission) to sever or damage unwanted plants.

By further example, U.S. Pat. No. 9,565,848 B2 to Stowe et al. entitled “Unwanted Plant Removal System,” herein incorporated by reference and referred to as the “Stowe Patent,” improves upon the unwanted plant recognition taught by the Christensen patent by employing a three-dimensional imager and improves upon the EM radiation emission taught by the Christensen patent by employing an array of semiconductor lasers.

### SUMMARY

The present disclosure further improves upon the unwanted plant recognition and the EM radiation emission aspects of both the Christensen patent and the Stowe patent.

The present disclosure describes various improvements that may be embodied, for example, as:

(1) a multi-spectral optical herbicide device;

(2) a multi-spectral optical herbicide;

(3) a multi-spectral optical fertilizer device;

(4) a multi-spectral optical fertilizer method;

(5) a multi-spectral optical plant treatment device incorporating combination, partial or complete, of a multi-spectral optical herbicide device of the present disclosure and a multi-spectral optical fertilizer device of the present disclosure; and

(6) a multi-spectral optical plant treatment method involving a combination, partial or complete, of a multi-spectral optical herbicide method of the present disclosure and a multi-spectral optical fertilizer method of the present disclosure.

Various embodiments of a multi-spectral optical herbicide device in accordance with the present disclosure encompass a vegetation scanner, an electromagnetic radiator and an optical herbicide controller for multi-spectral optical herbicide applications involving a discriminating recognition of an unwanted plant, and further involving an herbicide EM radiation emission for damaging the recognized unwanted plant in accordance with a photosynthesis termination and/or a photomorphogenesis termination of the present disclosure.

Various embodiments of a multi-spectral optical herbicide method in accordance with the present disclosure encompass multi-spectral optical herbicide applications involving a discriminating recognition of an unwanted plant, and further involving an herbicide EM radiation emission for damaging the recognized unwanted plant in accordance with a photosynthesis termination and/or a photomorphogenesis termination of the present disclosure.

Various embodiments of a multi-spectral optical fertilizer device in accordance with the present disclosure encompass a vegetation scanner, an electromagnetic radiator and an optical fertilizer controller for multi-spectral optical fertilizer applications involving a discriminating recognition of a wanted plant, and further involving a fertilizer EM radiation emission for enhancing the recognized wanted plant in accordance with a plant protection enhancement and/or a plant flavor enhancement of the present disclosure.

Various embodiments of a multi-spectral optical fertilizer method in accordance with the present disclosure encompass multi-spectral optical fertilizer applications involving a discriminating recognition of a wanted plant and further involving a fertilizer EM radiation emission for enhancing the recognized wanted plant in accordance with a plant protection enhancement and/or a plant flavor enhancement of the present disclosure.

Various embodiments of a multi-spectral optical plant treatment device in accordance with the present disclosure encompass a vegetation scanner, an electromagnetic radiator and a plant treatment controller for multi-spectral plant treatment applications involving a discriminating recognition between unwanted plants and wanted plants, and an herbicide EM radiation emission for damaging any recognized unwanted plant in accordance with a photosynthesis termination and/or a photomorphogenesis termination of the present disclosure and/or a fertilizer EM radiation emission for enhancing any recognized wanted plant in accordance with a plant protection enhancement and/or a plant flavor enhancement of the present disclosure.

Various embodiments of a multi-spectral optical plant treatment method in accordance with the present disclosure encompass multi-spectral plant treatment applications involving a discriminating recognition between unwanted plants and wanted plants, and an herbicide EM radiation emission for damaging any recognized unwanted plant in accordance with a photosynthesis termination and/or a photomorphogenesis termination of the present disclosure and/or a fertilizer EM radiation emission for enhancing any recognized wanted plant in accordance with a plant protection enhancement and/or a plant flavor enhancement of the present disclosure.

The foregoing embodiments and other embodiments of the present disclosure as well as various structures and advantages of the present disclosure will become further apparent from the following detailed description of various embodiments of the present disclosure read in conjunction with the accompanying drawings. The detailed description and drawings are merely illustrative of the present disclosure rather than limiting, the scope of the present disclosure being defined by the appended claims and equivalents thereof.

### BRIEF DESCRIPTION OF THE DRAWINGS

The present disclosure will present in detail the following description of preferred embodiments with reference to the following figures wherein:

FIG. 1 illustrates a block diagram representative of an exemplary embodiment of a multi-spectral optical plant treatment device in accordance with present disclosure;

FIG. 2 illustrates a flowchart representative of an exemplary embodiment of a multi-spectral plant treatment method in accordance with present disclosure;

FIG. 3 illustrates a block diagram representative of an exemplary embodiment of a multi-spectral optical herbicide device of FIG. 1 in accordance with present disclosure;

FIG. 4 illustrates a block diagram representative of an exemplary embodiment of a multi-spectral optical fertilizer device of FIG. 1 in accordance with present disclosure;

FIG. 5 illustrates an image of an exemplary embodiment of a motorized multi-spectral optical herbicide device of FIG. 3 in accordance with present disclosure;

FIG. 6 illustrates a schematic diagram of the motorized multi-spectral optical herbicide device of FIG. 5 in accordance with present disclosure;

FIG. 7A illustrates an image of an exemplary embodiment of an imaging/laser head of FIG. 5 in accordance with present disclosure;

FIG. 7B illustrates a schematic diagram of the imaging/laser head of FIG. 7A in accordance with present disclosure; and

FIG. 8 illustrates a flowchart representative of an exemplary embodiment of a time multiplexing plant treatment method in accordance with present disclosure.

### DETAILED DESCRIPTION

The present disclosure teaches numerous and various forms of (1) multi-spectral optical herbicide applications involving a discriminating recognition of an unwanted plant and an herbicide EM radiation emission for damaging the recognized unwanted plant in accordance with a photosynthesis termination of the present disclosure and/or a photomorphogenesis termination of the present disclosure, and (2) multi-spectral optical fertilizer applications involving a discriminating recognition of a wanted plant and a fertilizer EM radiation emission for enhancing the recognized wanted plant in accordance with a plant protection enhancement of the present disclosure and/or a plant flavor enhancement of the present disclosure.

In practice of the present disclosure, whether a particular type/species of plant is deemed as a wanted plant or an unwanted plant is dependent upon the application of principles described in the present disclosure. For example, weeds are typically unwanted plants and crops are typically wanted plants. However, in practice of the present disclosure, a particular type/species of weed may be provisionally deemed a wanted plant (e.g., a temporary need for a particular type/species of weed to bring nutrients and water up from deep in the soil and down from the air) and a particular type/species of crop may be provisionally deemed an unwanted plant (e.g., an immediate need to rapidly terminate a slowly decaying crop). Thus, an embodiment of the present disclosure involves a discriminating defining of wanted plants and unwanted plants dependent upon a temporal/spatial application of that particular embodiment.

For purposes of the description and the claims of the present disclosure, the term “damage” or any form thereof as related to a physiology of a plant is broadly defined as a diminishing or a termination of a physiology process of an unwanted plant, such as, for example, a diminishing or a termination of a photosynthesis process of an unwanted plant and/or a diminishing or termination of a photomorphogenesis process of an unwanted plant.

Also for purposes of the description and the claims of the present disclosure, the terms “herbicide EM radiation” or any form thereof is broadly defined as EM radiation having a wavelength absorbable by a plant to any degree that will cause damage to that plant.

In practice of multi-spectral optical herbicides applications of the present disclosure for damaging unwanted plants, a photosynthesis termination of an unwanted plant in accordance with the present disclosure is broadly defined herein as a photochemical bleaching of the unwanted plant to diminish or terminate a photosynthesis process within the unwanted plant. In one non-limiting exemplary embodiment of a photosynthesis termination of the present disclosure, herbicide EM radiation wavelengths/wavelength bands optimal for photochemical bleaching of targeted plant chemicals of the unwanted plant is in accordance with the following Table 1:

TABLE 1

| Plant | Peak Absorption | |
|---|---|---|
| Chemical | Wavelength | Absorption Wavelength Band |
| Chlorophyll A | 430 nm | 440 nm-450 nm; 670 nm-680 nm |
| Chlorophyll B | 460 nm | 440 nm-450 nm |
| Carotenoids | 470 nm | 440 nm-450 nm |
| Phycoerthrin | 565 nm | 440 nm-450 nm |

More particularly, for a particular plant chemical, the photochemical bleaching of the photosynthesis process may involve a targeted herbicide EM radiation emission at or around the peak absorption wavelength of one or more of the aforementioned plant chemicals, or herbicide EM radiation emission sweep(s)/chirp(s) within one or more of the absorption wavelength bands. Note the common absorption wavelengths bands for the plant chemicals represent an overlapping absorption capability of the plant chemicals.

Additionally, designated wavelength(s), duration(s) and intensity level(s) of herbicide EM radiation emission(s) to diminish or terminate photosynthesis within the unwanted plant are dependent upon various factors including, but not limited to, plant type, plant age and environmental conditions (e.g., wet or dry) of the unwanted plant derived from a vegetation image of the plant.

Further in practice of multi-spectral optical herbicide applications of the present disclosure for damaging unwanted plants, a photomorphogenesis termination of an unwanted plant in accordance with the present disclosure is defined herein as a photochemical dissociation of the unwanted plant to diminish or terminate a photomorphogenesis process within the unwanted plant. In one non-limiting exemplary embodiment of a photomorphogenesis termination of the present disclosure, herbicide EM radiation wavelengths/wavelength bands optimal for the photochemical dissociation of targeted plant chemicals of the unwanted plant is in accordance with the following Table 2:

TABLE 2

| Plant | Peak Absorption | |
|---|---|---|
| Chemical | Wavelength | Absorption Wavelength Band |
| Cryptochrome | 360 nm | 380 nm-390 nm |
| Phytochrome | 680 nm | 440 nm-450 nm; 720 nm-730 nm |
| Phototropin | 680 nm | 440 nm-450 nm |
| Tryptophan | 280 nm | 270 nm-280 nm |
| Tyorine | 274 nm | 270 nm-280 nm |
| Phenethylamine | 275 nm | 270 nm-280 nm |

More particularly, for a particular plant chemical, the photochemical dissociation of the photomorphogenesis process may involve a targeted herbicide EM radiation emission at or around the peak absorption wavelength of one or more of the aforementioned plant chemicals, or herbicide EM radiation emission sweep(s)/chirp(s) within one or more of the absorption wavelength bands. Note the common absorption wavelengths bands for the plant chemicals represent an overlapping absorption capability of the plant chemicals.

Additionally, designated wavelength(s), duration(s) and intensity level(s) of herbicide EM radiation emission(s) to terminate photomorphogenesis within the unwanted plant are dependent upon various factors including, but not limited to, plant type, plant age and environmental conditions (e.g., wet or dry) of the unwanted plant derived from a vegetation image of the plant.

For purposes of the description and the claiming of the present disclosure, the term “enhance” or any form thereof as related to a physiology of a plant is broadly defined as a reinforcement or an augmentation of a physiology process of a plant, such as, for example, a reinforcement or an augmentation of a photosynthesis process of a wanted plant and/or a reinforcement or an augmentation of a photomorphogenesis process of a wanted plant.

For purposes of the description and the claims of the present disclosure, the term “fertilizer EM radiation” or any form thereof is broadly defined as EM radiation having a wavelength absorbable by a plant to any degree that will enhance the plant.

In practice of multi-spectral optical fertilizer applications of the present disclosure for enhancing wanted plants, a plant protection enhancement of a wanted plant is broadly defined herein as a light interaction with the plant to enhance a self-protection of the wanted plant including, but not limited to, (1) a reinforced growth of trichrome structures to shade leaf(s) of the wanted plant and (2) an augmented production of a chemical sunscreen (e.g., glycosides) that may be toxic to insects (e.g., aphids and stinkbugs).

In one non-limiting exemplary embodiment, such light interaction may involve a targeted fertilizer EM radiation emission at or around a peak absorption wavelength of 280 nm, or a fertilizer EM radiation emission sweep/chirp within an absorption wavelength band of 270 nm-280 nm. In practice, an intensity level of such fertilizer EM radiation emission(s) will typically be lower than the intensity level of fertilizer EM radiation emission(s) used for photochemical dissociation of the photomorphogenesis process in accordance with Table 2 herein. Additionally, designated wavelength(s), duration(s) and intensity level(s) of the fertilizer EM radiation emission(s) to enhance the plant protection of the wanted plant are dependent upon various factors including, but not limited to, plant type, plant age and environmental conditions (e.g., wet or dry) of the wanted plant derived from a vegetation image of the plant.

Further in practice of multi-spectral optical fertilizer applications of the present disclosure for enhancing wanted plants, a plant flavor enhancement of a wanted plant is broadly defined herein as a light interaction with the plant to enhance a flavor of the wanted plant including, but not limited to, (1) a reinforced production of lycopene, beta-carotene, glycosides and/or hydroxycinnamic acid (e.g., enhances the flavor of wine) and (2) a reinforced production of anthocyanin (e.g., enhances the flavor of blueberries, blackberries and raspberries).

In one non-limiting exemplary embodiment, such light interaction may involve a targeted fertilizer EM radiation emission at or around a peak absorption wavelength of 280 nm or a fertilizer EM radiation emission at or around within a peak absorption wavelength of 380 nm, or a fertilizer EM radiation emission sweep/chirp within an absorption wavelength band of 270 nm-380 nm. In practice, an intensity level of the fertilizer EM radiation emission(s) will be lower than the intensity level of EM radiation emission(s) used for photochemical dissociation of the photomorphogenesis process in accordance with Table 2 herein. Additionally, designated wavelength(s), duration(s) and intensity level(s) of the fertilizer EM radiation emission(s) to enhance the plant flavor of the wanted plant are dependent upon various factors including, but not limited to, plant type, plant age and environmental conditions (e.g., wet or dry) of the wanted plant derived from a vegetation image of the plant.

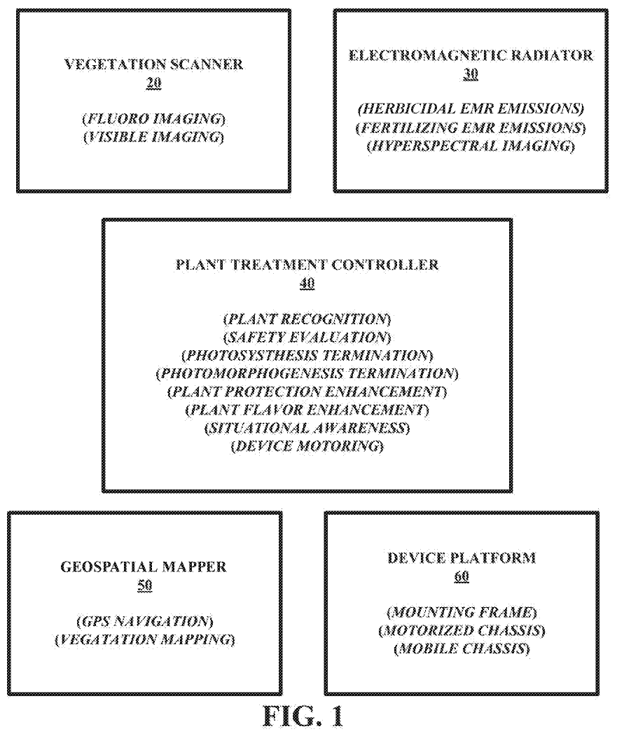

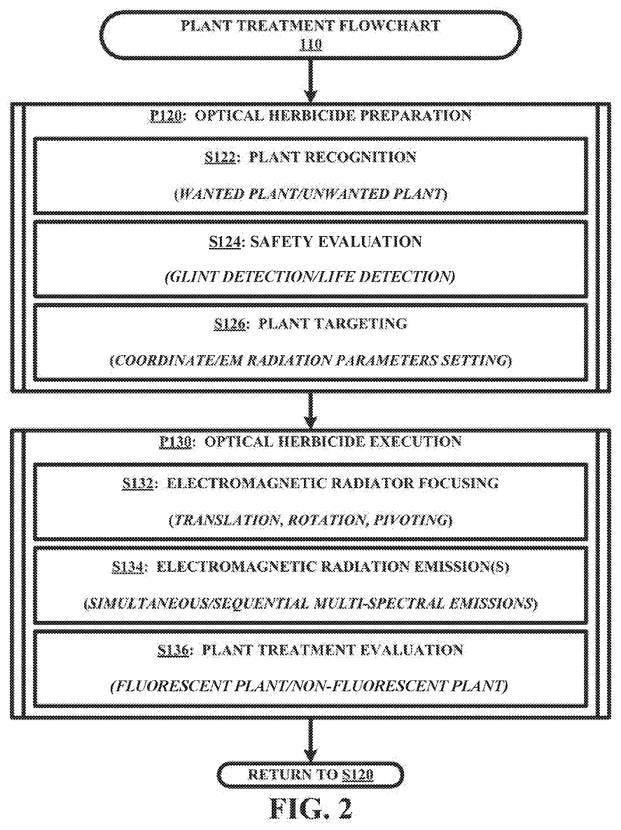

To facilitate an understanding of the present disclosure, the following description of FIG. 1 teaches exemplary embodiments of a multi-spectral plant treatment device in accordance with the present disclosure. From the description of the FIGS. 1 and 2, those having ordinary skill in the art will understand how to make and use additional embodiments of a multi-spectral optical plant treatment device as well as embodiments of a multi-spectral optical herbicide device and of a multi-spectral optical fertilizer device accordance with the present disclosure.

For purposes of the description and claims of the present disclosure, structural terms of the art including, but not limited to, “scanner,” “radiator,” “controller,” “mapper” and “platform” are to be interpreted as known in the art to which the present disclosure relates and as exemplarily described in the present disclosure.

Referring to FIG. 1, a multi-spectral plant treatment device 10 of the present disclosure employs a vegetation scanner 20, an electromagnetic radiator 30, a plant treatment controller 40, a geospatial mapper 50, and a device platform 60.

For purposes of the description and claims of the present disclosure, vegetation scanner 20 is broadly interpreted as any scanner for spatially imaging vegetation of a delineated ecosystem (e.g., a farm) utilizing or more imaging modalities (e.g., fluorescent imaging and/or visible imaging). Examples of vegetation scanner 20 include, but are not limited to, photosensitive arrays as taught by the Christensen patent, three-dimensional imagers as taught by the Stowe patent, and/or embodiments of fluoro-vegetation scanners of the present disclosure for implementing fluoro-vegetation scanning as exemplarily described in the present disclosure.

In practice of vegetation scanner 20, fluoro-vegetation scanning in accordance with the present disclosure is broadly defined herein as imaging of a fluorescent emission from chemical(s) in a plant, where the fluorescent emission is produced by EM radiation emission(s) at exciting wavelength(s) as known in the art to which the present disclosure relates.

In one exemplary embodiment, an identification of a fluorescent pattern in the image of the fluorescent emission by a plant serves as a basis for a recognition prediction of a pre-defined fluorescent pattern of a particular type/species of plant whereby the prediction is a discriminating recognition of the plant as a wanted plant or as an unwanted plant (e.g., an implementation of an artificial intelligence image recognition technique providing a prediction output as known in the art).

In a second exemplary embodiment, an identification of a fluorescent pattern in the image of the fluorescent emission of a plant serves as a basis for a recognition scoring of a pre-defined fluorescent pattern of a particular type/species of plant whereby the score relative to a threshold is a discriminating recognition of the plant as a wanted plant or as an unwanted plant (e.g., an implementation of an artificial intelligence image recognition technique providing a scoring output as known in the art).

Also in practice, fluoro-vegetation scanning of the present disclosure may incorporate visible-light imaging for purposes of supplementing or confirming a recognition of a plant as a wanted plant or an unwanted plant.

In one exemplary embodiment, the visible-light imaging of the plant may be derived from natural light and/or artificial light reflected from the vegetation, and an identification of visible characteristics in the image of a plant (e.g., leaf size, shape and/or color) serves as a basis for a recognition prediction of a pre-defined fluorescent pattern of a particular type/species of plant whereby the prediction is a discriminating recognition of the plant as a wanted plant or as an unwanted plant (e.g., an implementation of an artificial intelligence image recognition technique providing a scoring output as known in the art).

In a second exemplary embodiment, the visible imaging of the plant may be derived from natural light and/or artificial light reflected from the vegetation, and an identification of visible characteristics in the image of a plant (e.g., leaf size, shape and/or color) serves as a basis for a recognition scoring of a pre-defined fluorescent pattern of a particular type/species of plant whereby the score relative to a threshold is a discriminating recognition of the plant as a wanted plant or as an unwanted plant (e.g., an implementation of an artificial intelligence image recognition technique providing a scoring output as known in the art).

Still referring to FIG. 1, for purposes of the description and claims of the present disclosure, electromagnetic radiator 30 is broadly interpreted as any radiator including one or more electromagnetic radiation sources operable for focusing an emission of electromagnetic radiation of designated wavelength(s), duration(s) and intensity level(s) at a plant. Examples of electromagnetic radiator 30 include, but are not limited to, gas/solid-state lasers as taught by the Christensen patent, laser diode arrays as taught by the Stowe patent, and embodiments of electromagnetic radiators for implementing an amplified EM radiation as exemplarily described in the present disclosure.

In one exemplary embodiment of the present disclosure, electromagnetic radiator 30 includes an array of laser diodes, very-high-intensity light-emitting diodes or UV flash lamps with each diode/lamp operable for emitting electromagnetic radiation at a distinct wavelength or a distinct range of wavelengths.

In practice electromagnetic radiator 30, designated wavelength(s), duration(s) and intensity level(s) of the EM radiation emission by EM radiator 30 for a particular type/species of plant are pre-defined based on laboratory experiment/simulations and/or in-field testing of a photosynthesis termination, a photomorphogenesis termination, a plant protection enhancement and/or a plant flavor enhancement of the present disclosure.

In one exemplary embodiment, a matrix or a look-up table may be utilized to specify a designated wavelength(s), duration(s) and intensity level(s) of the EM radiation emission by EM radiator 30 for recognition of a particular type/species of plant. For example, each particular type/species of plant relevant to the embodiment is specified by plant type, plant age and environmental conditions and linked to designated wavelength(s), duration(s) and intensity level(s) of the EM radiation emission by EM radiator 30 derived from laboratory experiments, simulations and/or in-field testing of a photosynthesis termination, a photomorphogenesis termination, a plant protection enhancement and/or a plant flavor enhancement of the present disclosure.

Further in practice of electromagnetic radiator 30, an amplified EM radiation of the present disclosure is broadly defined herein as simultaneous EM radiation emissions or sequential EM radiation emissions by electromagnetic radiator 30 designed to predispose an unwanted plant for a photosynthesis termination and/or a photomorphogenesis termination, or to predispose a wanted plant for a plant protection enhancement and/or a plant flavor enhancement. An amplified EM radiation may include absorbable or non-absorbable wavelengths of a particular type/species of plant.

For example, a pre-destruction of anthocyanins and beta-carotene in an unwanted plant will leave that unwanted plant more susceptible to UV radiation at 280 nm during a subsequent photosynthesis termination. By further example, an outer wall of the unwanted plant may be sliced under near IR radiation between wavelengths of 1.55 μm and 1.65 μm prior to or concurrent with a photosynthesis termination and/or a photomorphogenesis termination. Also by example, damaging a cryptochrome of an unwanted plant at 360 nm will cause a stroma to cut off CO2, which will cause asphyxiation of the plant.

Also in practice, EM radiator 30 may be utilized for hyperspectral imaging as known in the art to which the present disclosure relates to serve as a basis for a discriminating plant recognition and/or a confirmation of a photosynthesis termination and/or a photomorphogenesis termination.

In one exemplary embodiment, the hyperspectral imaging of the plant may be derived from EM radiation reflected from a plant, and an identification of hyperspectral characteristics in the image of the plant (e.g., high resolution spatial information along with spectral data) serves as a basis for a recognition prediction of a pre-defined fluorescent pattern of a particular type/species of plant whereby the prediction is a discriminating recognition of the plant as a wanted plant or as an unwanted plant (e.g., an implementation of an artificial intelligence image recognition technique providing a scoring output as known in the art).

In a second exemplary embodiment, he hyperspectral imaging of the plant may be derived from EM radiation reflected from a plant, and an identification of hyperspectral characteristics in the image of a plant (e.g., high resolution spatial information along with spectral data) serves as a basis for a recognition scoring of a pre-defined fluorescent pattern of a particular type/species of plant whereby the score relative to a threshold is a discriminating recognition of the plant as a wanted plant or as an unwanted plant (e.g., an implementation of an artificial intelligence image recognition technique providing a scoring output as known in the art).

Still referring to FIG. 1, for purposes of the description and claims of the present disclosure, geospatial mapper 50 is broadly interpreted as a mapper for mapping location information related to a delineated ecosystem. Examples of geospatial mapper 50 include, but are not limited to, global positioning system (GPS) modules as known in the art to which the present disclosure relates and light detection and ranging (LIDAR) modules as known in the art to which the present disclosure relates.

In one exemplary embodiment, geospatial mapper 50 includes a GPS module for tracking a location of multi-spectral plant treatment device 10 within a delineated ecosystem and/or include a LIDAR module for determining a distance of multi-spectral plant treatment device 10 from a wanted plant or an unwanted plant that is derived from a vegetation LIDAR mapping of the ecosystem.

Still referring to FIG. 1, for purposes of the description and claims of the present disclosure, device platform 60 is broadly interpreted an any platform for facilitating a transportation or a support of multi-spectral plant treatment device 10 within the delineated ecosystem. Examples of device platform 60 include, but are not limited to, a motorized chassis for self-transport of multi-spectral plant treatment device 10, a non-motorized mobile chassis (e.g., a trailer) attached to a vehicle (e.g., a truck) for a passive transport of multi-spectral plant treatment device 10, and a mountable frame for attachment to a vehicle (e.g., a tractor) for an active support.

Still referring to FIG. 1, for purposes of the description and claims of the present disclosure, plant treatment controller 40 is broadly defined as any mechanism that controls an execution of one or more operational features of multi-spectral plant treatment device 10. Examples of such operational features in accordance with the present disclosure include, but are not limited to, plant recognition, safety evaluation, photosynthesis termination, photomorphogenesis termination, plant protection enhancement, plant flavor enhancement, situational awareness and device motoring.

In one exemplary embodiment, plant treatment controller 40 broadly encompasses all structural configurations, as understood in the art to which the present disclosure relates and as exemplarily described in the present disclosure, of an application-specific main board or an application-specific integrated circuit for controlling an application of various operational features of the present disclosure as exemplarily described in the present disclosure. The structural configuration of plant treatment controller 40 may include, but is not limited to, processor(s), computer-usable/computer readable storage medium(s), operating system(s), application module(s), peripheral device controller(s), slot(s) and port(s).

The term “application module” broadly encompasses an application incorporated within or accessible by a plant treatment controller 40 consisting of an electronic circuit (e.g., electronic components and/or hardware) and/or an executable program (e.g., executable software stored on non-transitory computer-readable medium(a) and/or firmware) for executing one or more operational features of multi-spectral optical herbicide device 10.

To facilitate an understanding of optical herbicide controller 40, the following description of FIG. 2 teaches exemplary embodiments of a multi-spectral plant treatment method in accordance with the present disclosure. From the description of FIG. 2, those having ordinary skill in the art will understand how to make and use additional embodiments of plant treatment controller 40 in accordance with the present disclosure and how to formulate and execute embodiments of a multi-spectral optical herbicide method and a multi-spectral optical fertilizer method in accordance with the present disclosure.

Referring to FIG. 2, a flowchart 110 is representative of a plant treatment method of the present disclosure involving a plant treatment preparation phase P120 and a plant treatment execution phase P130.

The plant treatment preparation phase P120 includes three steps. The first step is a stage S122 encompassing plant treatment controller 40 implementing recognition of a plant as a wanted plant or an unwanted plant dependent upon whether the application is a photosynthesis termination, a photomorphogenesis termination, a plant protection enhancement and/or a plant flavor enhancement.

In practice, the plant recognition is a process of detecting and identifying a particular type/species of plant in digital image(s) generated by vegetation scanner 20 including, but not limited to, fluoro vegetation images and visible vegetation images as described elsewhere in the present disclosure. The plant recognition may be based on fluoro-vegetation scanning as described elsewhere in the present disclosure and may optionally include hyperspectral images generated by EM radiator 30.

In one exemplary embodiment of stage S122, plant treatment controller 40 implements a machine-learning algorithm as known in the art to which the present disclosure relates (e.g., an algorithm developed using unsupervised learning, supervised learning and/or reinforcement learning) to detect and identify one or more particular types/species of plant in the image(s) from among a variety of types/species of plants listed in the matrix/look-up table.

Still referring to FIG. 2, a second step is a stage S124 encompassing plant treatment controller 40 implementing a glint detection and/or a life detection within the delineated ecosystem of the digital image(s) processed for plant recognition.

In practice, glint detection is a process that detects any type of reflective object within the digital image(s) processed for plant recognition that may cause a hazard if EM radiation is reflected off the object(s)

In one exemplary embodiment, plant treatment controller 40 controls an emission by EM radiator 30 of a non-herbicide/non-fertilizer EM radiation and measures a polarization and intensity of the EM radiation to identify reflective objects (e.g., metal or broken glass). If reflective object(s) is (are) detected in the digital image, then plant treatment controller 40 deems the condition unsafe, ends the optical herbicide and communicates the unsafe condition to an operator. Otherwise, if reflective object(s) is (are) not detected in the digital image, then plant treatment controller 40 deems the condition safe and may proceed to stage S126.

Alternatively, in practice, stage S124 may be performed during emission of an herbicide/fertilizer EM radiation burst, chirp or sweep.

In practice, life detection is a process that detects any type of human or animal object within the digital image(s) processed for plant recognition.

In one exemplary embodiment, plant treatment controller 40 implements a machine-learning algorithm as known in the art to which the present disclosure relates (e.g., an algorithm developed using unsupervised learning, supervised learning and/or reinforcement learning) to detect human or animal life in digital image(s). If life is detected in the digital image(s) and within range of an EM radiation emission, then plant treatment controller 40 deems the condition unsafe, ends the plant treatment and communicates the unsafe condition to an operator. Otherwise, if life is not detected in the digital image(s), then plant treatment controller 40 deems the condition safe and may proceed to stage S126.

Still referring to FIG. 2, for multi-spectral optical herbicide applications, if an unwanted plant is detected and identified in stage S122, then stage S126 encompasses plant treatment controller 40 targeting the plant for photosynthesis termination or photomorphogenesis termination involving a setting of coordinates of the unwanted plant for targeting the unwanted plant, and a selecting of EM radiation parameters (e.g., wavelength, duration, intensity level) via matrix(ces)/look-up table(s) corresponding to a photosynthesis termination and/or a photomorphogenesis termination according to the present disclosure.

For multi-spectral optical fertilizer applications, a wanted plant is detected and identified in stage S122, then stage S126 may encompass plant treatment controller 40 targeting the plant for plant protection enhancement or plant flavor enhancement involving a setting of coordinates of the wanted plant for targeting the wanted plant and a selecting of EM radiation parameters (e.g., wavelength, duration, intensity level) via matrix(ces)/look-up table(s) corresponding to a plant protection enhancement and/or a plant flavor enhancement according to the present disclosure.

In practice, the setting of the coordinates may be accomplished as set forth by the Christensen patent and/or the Stowe patent, or by an implementation of imaging processing technique(s) as known in the art to which the present disclosure relates for determining a position of an object within a coordinate system.

Still referring to FIG. 2, flowchart 110 proceeds to plant treatment execution phase P130 for treating a targeted plant under safe conditions in accordance with stages S122-S126.

A stage S132 of phase P130 encompasses plant treatment controller 40 controlling a focusing of electromagnetic radiator 30 on the unwanted/wanted plant, particularly at a stem of the unwanted/wanted plant.

In one exemplary embodiment, electromagnetic radiator 30 employs a set of optics (e.g., lenses and/or mirrors) that are translatable, rotatable and/or pivotable by plant treatment controller 40 to focus the output of electromagnetic radiator 30 on the unwanted/wanted plant.

In a second exemplary embodiment, electromagnetic radiator 30 employs a support mechanism that is translatable, rotatable and/or pivotable by plant treatment controller 40 to focus the output of electromagnetic radiator 30 on the unwanted/wanted plant.

In practice, focusing of the output of electromagnetic radiator 30 on the unwanted/wanted plant may be accomplished as set forth in the Christensen patent and/or the Stowe patent, or by an implementation of imaging processing technique(s) as known in the art to which the present disclosure relates for focusing on an object within a coordinate system.

Still referring to FIG. 2, a stage S134 of phase P130 encompasses plant treatment controller 40 controlling an emission of EM radiation by electromagnetic radiator 30 to perform a photosynthesis termination, a photomorphogenesis termination, a plant protection enhancement and/or a plant flavor enhancement according to the present disclosure.

In one exemplary embodiment, plant treatment controller 40 may control a single EM radiation emission by electromagnetic radiator 30.

In a second exemplary embodiment, the plant treatment controller 40 may control simultaneous EM radiation emissions by electromagnetic radiator 30, particularly to amplify the plant treatment as described in the present disclosure.

In a second exemplary embodiment, the plant treatment controller 40 may control sequential EM radiation emissions by electromagnetic radiator 30 particularly to amplify the plant treatment as described in the present disclosure.

Still referring to FIG. 2, a stage S136 of phase S130 encompasses plant treatment controller 40 controlling an evaluation of the optical herbicide or optical fertilizer.

In practice, a failure to damage an unwanted flower via photosynthesis termination and/or photomorphogenesis termination will result in the unwanted flower maintaining a capability of fluorescence emission as well as the hyperspectral characteristics of the unwanted plant. In one exemplary embodiment of stage S136, plant treatment controller 40 determines whether the unwanted flower is no longer capable of fluorescence emission and/or has altered/corrupted hyperspectral characteristics derived from previous hyperspectral imaging of the unwanted plant.

If the unwanted flower is still capable of fluorescence emission and/or has unaltered/uncorrupted hyperspectral characteristics, then plant treatment controller 40 repeats stages S132 and S134. Otherwise, if the unwanted flower in incapable of fluorescence emission and/or has altered/corrupted hyperspectral characteristics, then plant treatment controller 40 returns to phase P120 to process data for another plant or terminates flowchart 110.

Conversely, in practice, damage to a wanted flower via plant protection enhancement and/or plant flavor enhancement may result in the wanted flower being incapable of fluorescence emission and/or having altered/corrupted hyperspectral characteristics. In one exemplary embodiment of stage S136, plant treatment controller 40 determines if the wanted flower is still capable of fluorescence emission and/or having altered/corrupted hyperspectral characteristics. Plant treatment controller 40 notes the evaluation for informational mapping purposes and returns to phase P120 to process data for another plant or terminates flowchart 110.

Referring to FIGS. 1 and 2, in practice, a multi-spectral optical herbicide device of the present disclosure will employ a vegetation scanner 20 discriminately recognizing unwanted plants, an electromagnetic radiator 30 operable for emitting EM radiation associated with photosynthesis termination and/or photomorphogenesis termination of the unwanted plant and an optical herbicide controller version of plant treatment controller 40 for controlling photosynthesis termination and/or photomorphogenesis of the unwanted plant in accordance with flowchart 110.

Also in practice, a multi-spectral optical fertilizer device of the present disclosure will employ a vegetation scanner 20 discriminately recognizing wanted plants, an electromagnetic radiator 30 operable for emitting EM radiation associated with plant protection enhancement and/or plant flavor enhancement of the wanted plant and an optical fertilizer controller version of plant treatment controller 40 for controlling plant protection enhancement and/or plant flavor enhancement of the wanted plant in accordance with flowchart 110.

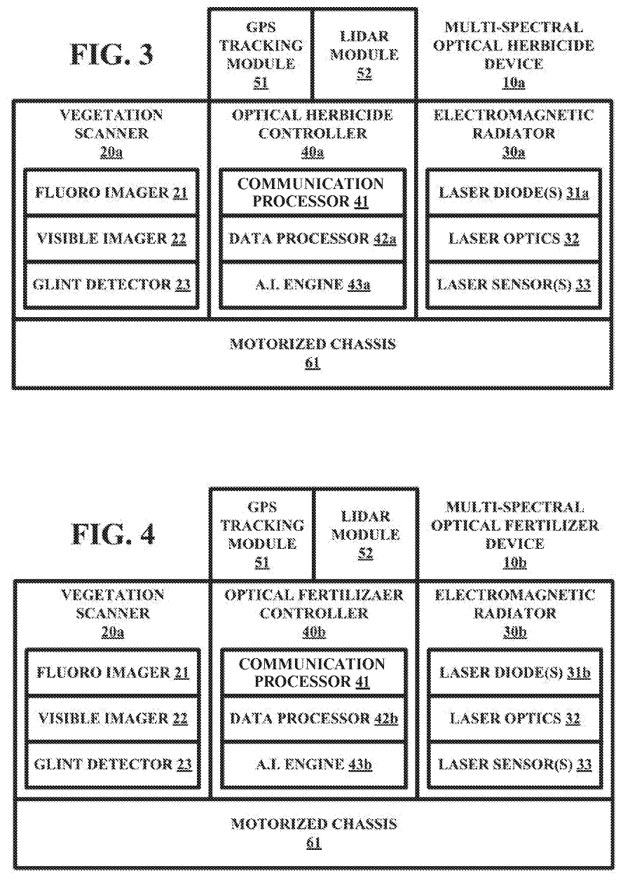

To facilitate a further understanding of the present disclosure, the following description of FIGS. 3-8 teaches additional exemplary embodiments of a multi-spectral optical herbicide device and a multi-spectral optical fertilizer device in accordance with the present disclosure. From the description of the FIGS. 3-8, those having ordinary skill in the art will understand how to make and use additional embodiments of a multi-spectral optical herbicide device and a multi-spectral optical fertilizer device in accordance with the present disclosure.

Referring to FIG. 3, a multi-spectral optical herbicide device 10a employs a vegetation scanner 20a, an electromagnetic radiator 30a, an optical herbicide controller 40a, a GPS tracking module 51, LIDAR module 52 and a motorized/mobile chassis 61.

Optical herbicide controller 40a includes a communication processor 41 for data/signal/command communications with the other components and for external communication with an operator.

Optical herbicide controller 40a further includes a data processor 42 for processing image data from vegetation scanner 20a, coordinate and other data from GPS tracking module 51 and mapping data from LIDAR module 52. Data processor 42 further generates focusing and emission data/signals/commands for electromagnetic radiator 30a.

Optical herbicide controller 40a further includes an artificial intelligence engine 43a for unwanted plant recognition, safety evaluation, plant targeting, EM radiator focusing and herbicide treatment evaluation as described in the present disclosure.

Laser diode(s) 31a of electromagnetic radiator 30a are configured to emit EM radiation at designed wavelength(s), duration(s) and intensity level(s) for a photosynthesis termination and/or a photomorphogenesis termination of an unwanted plant via matrix(ces)/look-up table(s) as described in the present disclosure.

In operation, vegetation scanner 20a employs a fluoro imager 21 and visible imager 22 for generating fluoro vegetation images/visible vegetation images of vegetation in a delineated ecosystem. Glint detector 23 of vegetation scanner 20a analyzes and measures any reflective objects in the visible vegetation images generated visible imager 22. The fluoro vegetation images/visible vegetation images and glint data communicated to A.I. engine 43a via communication processor 41 for unwanted plant recognition and safety evaluation.

If the conditions are safe for a photosynthesis termination and/or a photomorphogenesis termination of a recognized unwanted plant, then A.I. engine 43a sets coordinates and radiation parameters as described in the present disclosure via image data, GPS data and LIDAR data for the photosynthesis termination and/or the photomorphogenesis termination. Data processor 42a generates data/signals/commands to a laser optics 32 of electromagnetic radiator 30a (e.g., lens(es) and/or mirror(s)) to focus the laser diode(s) 31a of electromagnetic radiator 30a on an unwanted plant, and activates laser diode(s) 31a to perform the photosynthesis termination and/or a photomorphogenesis termination.

Subsequently, data processor 42a performs an optical herbicide evaluation of the unwanted plant via fluoro imager 21 and laser sensor(s) 33 and decides if further treatment of the unwanted plant is needed or if the optical herbicide application should continue as described in the present disclosure.

In practice, laser diode(s) 31a may be utilized to perform optical herbicide evaluation, and laser sensor(s) 33 may be omitted from electromagnetic radiator 30a.

Data processor 42a may also operate the motorized chassis 61 to position device 10a as needed.

Referring to FIG. 4, a multi-spectral optical fertilizer device 10b employs a vegetation scanner 20a, an electromagnetic radiator 30b, an optical fertilizer controller 40b, a GPS tracking module 51, LIDAR module 52 and motorized chassis 61.

Optical fertilizer controller 40b includes a communication processor 41 for data/signal/command communications with the other components and for external communication with an operator.

Optical fertilizer controller 40b further includes a data processor 42b for processing image data from vegetation scanner 20a, coordinate data from GPS tracking module 51 and mapping data from LIDAR module 52. Data processor 42 further generates focusing and emission data/signal/commands for electromagnetic radiator 30b.

Optical fertilizer controller 40a further includes an artificial intelligence engine 43b for wanted plant recognition, safety evaluation, plant targeting, EM radiator focusing and fertilizer treatment evaluation as described in the present disclosure.

Laser diode(s) 31b of electromagnetic radiator 30b are configured to emit EM radiation at designed wavelength(s), duration(s) and intensity level(s) for a plant protection enhancement and/or a plant flavor enhancement via matrix(ces)/look-up table(s) as described in the present disclosure.

In operation, vegetation scanner 20a employs a fluoro imager 21 and visible imager 22 for generating fluoro vegetation images/visible vegetation images of vegetation in a delineated ecosystem. Glint detector 23 of vegetation scanner 20a analyzes and measures any reflective objects in the visible vegetation images generated visible imager 22. The fluoro vegetation images/visible vegetation images and glint data communicated to A.I. engine 43b via communication processor 41 for wanted plant recognition and safety evaluation.

If the conditions are safe for plant protection enhancement and/or plant flavor enhancement, then A.I. engine 43b sets coordinates and radiation parameters via image data, GPS data and LIDAR data for plant protection enhancement and/or plant flavor enhancement. Data processor 42b generates data/signals/commands to a laser optics 32 of electromagnetic radiator 30b (e.g., lens(es) and/or mirror(s)) to focus the laser diode(s) 31b of electromagnetic radiator 30a on a wanted plant, and activates laser diode(s) 31ba to perform the plant protection enhancement and/or plant flavor enhancement.

Subsequently, data processor 42b performs an optical fertilizer evaluation of the wanted plant via fluoro imager 21 and laser sensor(s) 33 and decides if further treatment is needed of the wanted plant or if the optical fertilizer application should continue as described in the present disclosure.

In practice, laser diode(s) 31b may be utilized to perform optical fertilizer evaluation and laser sensor(s) 33 may be omitted from electromagnetic radiator 30b.

Data processor 42b may also operate the motorized chassis 61 to position device 10a as needed.

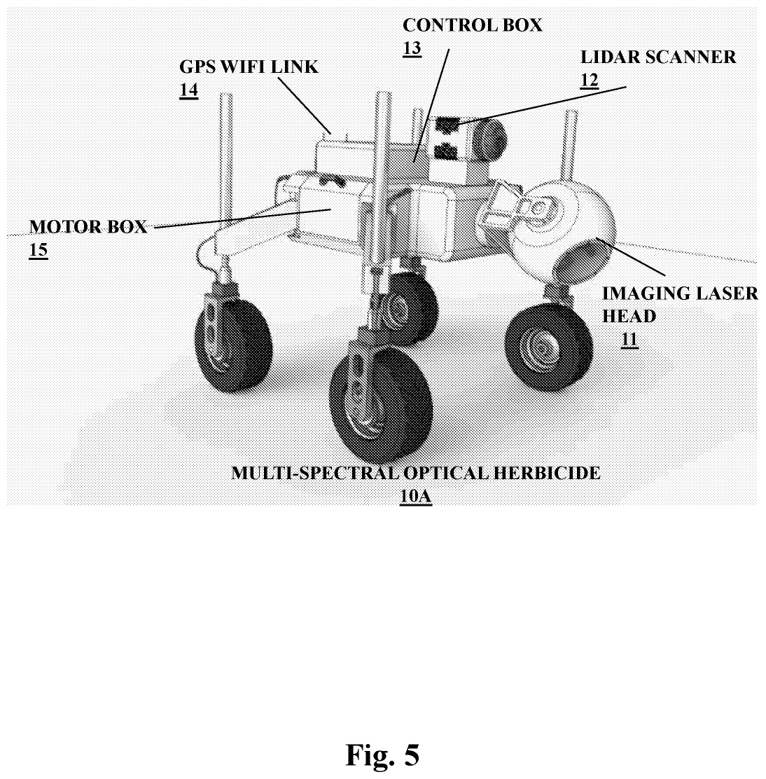

Referring to FIG. 5, a multi-spectral optical herbicide 10a′ is a version of multi-spectral optical herbicide 10a (FIG. 3) having a chassis supporting an imaging/laser head 11, a LIDAR scanner 12, a control box 13 and a GPS Wi-Fi link 14. Alternative imaging, ranging, identification, control, location and communication components may be used as will occur to those skilled in the art in view of this disclosure.

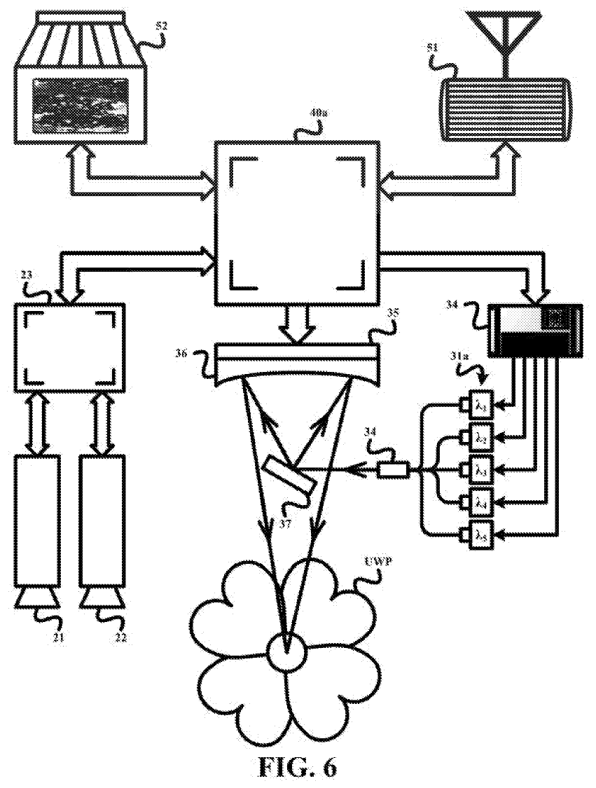

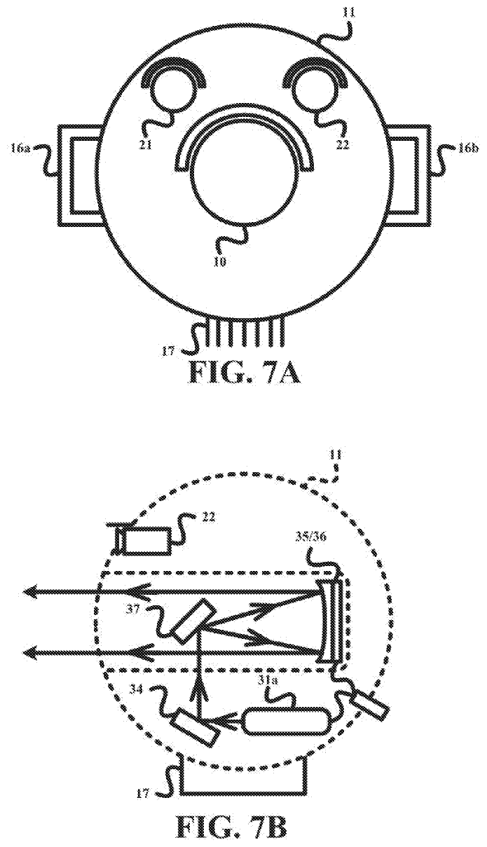

As shown in FIG. 6, control box 13 (FIG. 5) encloses glint detector 23 and optical herbicide controller 40a, which has various communication channels symbolized by the arrows. Fluoro imager 21 and visible imager 22 are located within imaging/laser head 11 as shown in FIGS. 7A and 7B. Laser diode(s) 31a, a fiber coupler 34, a mirror controller 35, and mirrors 36/37 are also located within imaging/laser head 11 as shown in FIGS. 7A and 7B.

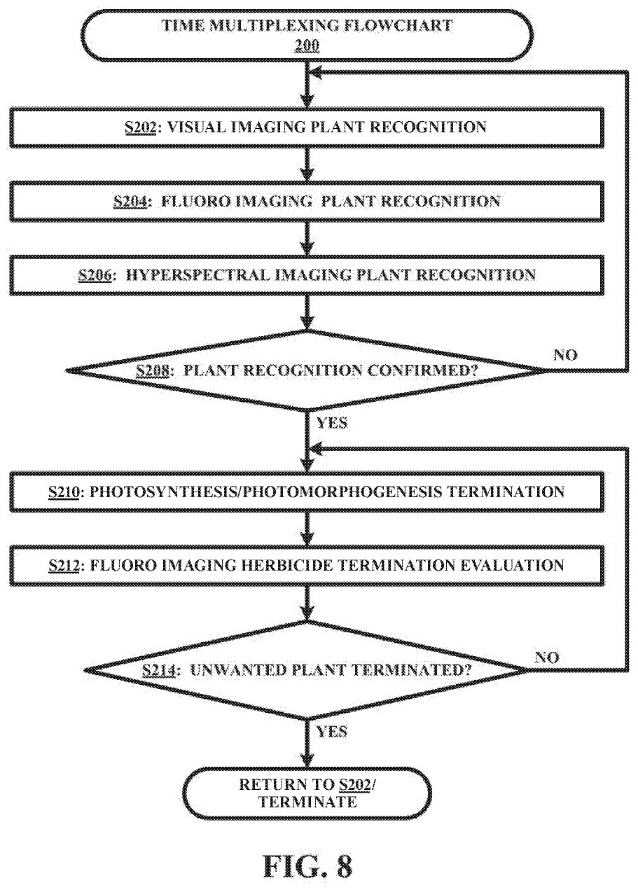

Referring to FIG. 8, flowchart 200 is representative of time-multiplexing plant treatment method of the present disclosure executable by any embodiment of multi-spectral plant treatment device 10 (FIG. 1) for an optical herbicide application, particularly multi-spectral optical herbicide 10a (FIG. 3).

A stage S202 of flowchart 200 encompasses a first plant recognition of an unwanted plant involving a detection and identification of the unwanted plant within a camera image acquired by visual imager 22.

A stage S204 of flowchart 200 encompasses a second confirming plant recognition of the unwanted plant involving a detection and identification of the unwanted plant within a fluoro vegetation image acquired by fluoro imager 21.

A stage S206 of flowchart 200 encompasses a third confirming plant recognition of the unwanted plant involving a detection and identification of the unwanted plant via a multiplexing activation of laser diode(s) 31a. For example, with a first laser diode off and a second laser diode on and targeted on the plant, a third plant recognition of the unwanted plant involves a detection and identification of the unwanted plant within a hyperspectral image acquired by the first laser diode.

Subsequently, withe the second laser diode off and a third laser diode on and targeted on the plant, a fourth plant recognition of the unwanted plant involves a detection and identification of the unwanted plant within a hyperspectral image acquired by the second laser diode.

If a stage S208 of flowchart 200 determines an unwanted plant recognition of stage S202 was not confirmed by stages S204 and S206, then flowchart 200 returns to stage S202 to attempt to recognize another unwanted plant or flowchart 200 is terminated if the optical herbicide application is ending.

Alternatively, if stage S208 of flowchart 200 determines an unwanted plant recognition of stage S204 was not confirmed by stages S202 and S206, then flowchart 200 returns to stage S202 to attempt to recognize another unwanted plant (or flowchart 200 is terminated if the optical herbicide application is ending).

Otherwise, if stage S208 of flowchart 200 determines the unwanted plant recognition of stage S202 was confirmed by stages S204 and S206 (or determines the unwanted plant recognition of stage S204 was confirmed by stages S202 and S206), then flowchart 200 proceeds to stage S210 to execute an perform a photosynthesis termination and/or a photomorphogenesis termination sequentially involving a targeting geometry sequencing of the unwanted plant, a powering up of the laser diode(s), a laser fire safety verification (via glint/3D data) and an activation of the laser diodes.

A stage S212 of flowchart 200 encompasses an herbicide termination evaluation of the unwanted plant involving a fluorescent imaging of unwanted plant via the laser diodes and optionally a hyperspectral imaging of unwanted plant via the laser diodes.

If a stage S214 of flowchart 200 determines the unwanted plant was terminated via a lack of a fluorescence emission by the unwanted plant (and/or altered/corrupted hyperspectral characteristics of the unwanted plant), then flowchart 200 returns to stage S202 to attempt to recognize another unwanted plant (or flowchart 200 is terminated if the optical herbicide application is ending).

Otherwise, if stage S214 of flowchart 200 determines the unwanted plant was not terminated via fluorescence emission by the unwanted plant (and/or unaltered/uncorrupted hyperspectral characteristics of the unwanted plant), then flowchart 20 returns to stage S210 to repeat the photosynthesis termination and/or the photomorphogenesis termination of the unwanted plant until the unwanted plant is deemed terminated (or flowchart 200 is terminated if the optical herbicide application is ending).

In practice, flowchart 200 is executable as would be appreciated by those having ordinary skill in the art to which the present disclosure relates by any embodiment of multi-spectral plant treatment device 10 (FIG. 1) for an optical fertilizer application, particularly multi-spectral optical fertilizer 10b (FIG. 4). For such optical fertilizer application, stages S202-S214 are executed within a context of a plant protection enhancement and/or a plant flavor enhancement of a confirmed recognized wanted plant.

Referring to FIGS. 1-8, those of ordinary skill in the art to which the present disclosure relates will appreciate the numerous advantages and benefits of the present disclosure including, but not limited to, herbicide applications for unwanted plants and fertilizer applications of wanted plants at a reasonable cost and diminution of environmental issues.

In interpreting the appended claims, it should be understood that: (a) the word “comprising” does not exclude the presence of other elements or acts than those listed in a given claim; (b) the word “a” or “an” preceding an element does not exclude the presence of a plurality of such elements; (c) any reference signs in the claims do not limit their scope; and (d) no specific sequence of acts is intended to be required unless specifically indicated.

Having described preferred embodiments for herbicide and fertilizer/enhancement systems and methods (which are intended to be illustrative and not limiting), it is noted that modifications and variations can be made by persons skilled in the art in light of the above teachings. It is therefore to be understood that changes may be made in the particular embodiments of the disclosure disclosed which are within the scope of the embodiments disclosed herein as outlined by the appended claims. Having thus described the details and particularity required by the patent laws, what is claimed and desired to be protected by Letters Patent is set forth in the appended claims.

What is claimed is:

1. A multi-spectral plant treatment device (10), comprising:
a vegetation scanner (20) operable to generate at least one vegetation image;
an electromagnetic radiator (30) operable to emit electromagnetic radiation; and
a plant treatment controller (40) in communication with the vegetation scanner (20) and the electromagnetic radiator (30),
wherein, responsive to a generation of the at least one vegetation image by the vegetation scanner (20), the plant treatment controller (40) is configured to recognize an unwanted plant in the at least one vegetation image,
wherein, responsive to a recognition by the plant treatment controller (40) of the unwanted plant in the at least one vegetation image, the plant treatment controller (40) is further configured to control an herbicide emission of the electromagnetic radiation by the electromagnetic radiator (30) for at least one of a photosynthesis termination of the unwanted plant and a photomorphogenesis of the unwanted plant; and
wherein the plant treatment controller (40) is further configured to set parameters of the herbicide emission of the electromagnetic radiation by the electromagnetic radiator (30) based on at least one of a plant type of the unwanted plant and a plant age of the unwanted plant derived from the recognition by the plant treatment controller (40) of the unwanted plant in the at least one vegetation image.

2. The multi-spectral plant treatment device (10) of claim 1,
wherein the vegetation scanner (20) includes a fluoro imager operable to generate a fluoro vegetation image; and
wherein the plant treatment controller (40) being configured to recognize the unwanted plant includes:
the plant treatment controller (40) being configured to recognize at least one fluorescent pattern of the unwanted flower in the fluoro vegetation image; and
the plant treatment controller (40) being configured to assert the recognition of the unwanted plant in the at least one vegetation image based on a recognition by the plant treatment controller (40) of the at least one fluorescent pattern in the fluoro vegetation image.

3. The multi-spectral plant treatment device (10) of claim 1,
wherein the vegetation scanner (20) includes a visible imager operable to generate a visible vegetation image; and
wherein the plant treatment controller (40) being configured to recognize the unwanted plant includes:
the plant treatment controller (40) being configured to recognize at least one visible characteristic of the unwanted flower in the visible vegetation image; and
the plant treatment controller (40) being configured to assert the recognition of the unwanted plant in the at least one vegetation image based on a recognition by the plant treatment controller (40) of at least one visible characteristic of the unwanted flower in the visible vegetation image.

4. The multi-spectral plant treatment device (10) of claim 1,
wherein the plant treatment controller (40) is further configured to control a hyperspectral imaging emission of the electromagnetic radiation by the electromagnetic radiator (30) for generating a hyperspectral vegetation image; and
wherein the plant treatment controller (40) being configured to recognize the unwanted plant includes:
the plant treatment controller (40) configured to recognize at least one hyperspectral characteristic of the unwanted flower in the hyperspectral vegetation image; and
the plant treatment controller (40) configured to assert the recognition of the unwanted plant in the at least one vegetation image based on a recognition by the plant treatment controller (40) of at least one hyperspectral characteristic of the unwanted flower in the hyperspectral vegetation image.

5. The multi-spectral plant treatment device (10) of claim 2,
wherein the vegetation scanner (20) further includes a visible imager operable to generate a visible vegetation image; and
wherein the plant treatment controller (40) being configured to recognize the unwanted plant in the at least one vegetation image further includes:
the plant treatment controller (40) being configured to recognize at least one visible characteristic of the unwanted flower in the visible vegetation image; and
the plant treatment controller (40) being configured to assert the recognition of the unwanted plant in the at least one vegetation image based on the recognition by the plant treatment controller (40) of the at least one fluorescent pattern of the unwanted flower in the fluoro vegetation image and based on a recognition by the plant treatment controller (40) of at least one visible characteristic of the unwanted flower in the visible vegetation image.

6. The multi-spectral plant treatment device (10) of claim 2,
wherein the plant treatment controller (40) is further configured to control a hyperspectral imaging emission of the electromagnetic radiation by the electromagnetic radiator (30) for generating a hyperspectral vegetation image; and
wherein the plant treatment controller (40) being configured to recognize the unwanted plant in the at least one vegetation image includes:
the plant treatment controller (40) configured to recognize at least one hyperspectral characteristic of the unwanted flower in the hyperspectral vegetation image; and
the plant treatment controller (40) configured to assert the recognition of the unwanted plant in the at least one vegetation image based on the recognition by the plant treatment controller (40) of the at least one fluorescent pattern of the unwanted flower in the fluoro vegetation image and based on a recognition by the plant treatment controller (40) of at least one hyperspectral characteristic of the unwanted flower in the hyperspectral vegetation image.

7. The multi-spectral plant treatment device (10) of claim 1,
wherein the vegetation scanner (20) includes a fluoro imager operable to generate a fluoro vegetation image;
wherein the plant treatment controller (40) is further configured to recognize at least one fluorescent pattern of the unwanted flower in the fluoro vegetation image; and
wherein, subsequent the at least one of the photosynthesis termination of the unwanted plant and the photomorphogenesis of the unwanted plant, the plant treatment controller (40) is further configured to evaluate the at least one of the photosynthesis termination of the unwanted plant and the photomorphogenesis of the unwanted plant based on a recognition by the plant treatment controller (40) of at least one fluorescent pattern of the unwanted flower in the fluoro vegetation image or a failure by the plant treatment controller (40) to recognize at least one fluorescent pattern of the unwanted flower in the fluoro vegetation image.

8. The multi-spectral plant treatment device (10) of claim 1,
wherein the plant treatment controller (40) is further configured to recognize a wanted plant in the at least one vegetation image by the vegetation scanner (20),
wherein, responsive to an assertion by the plant treatment controller (40) of a recognition of the wanted plant in the at least one vegetation image, the plant treatment controller (40) is further configured to control a fertilizer emission of the electromagnetic radiation by the electromagnetic radiator (30) for at least one of a plant protection enhancement of the wanted plant and a plant flavor enhancement of the wanted plant; and
wherein the plant treatment controller (40) is further configured to set parameters of the fertilizer emission of the electromagnetic radiation by the electromagnetic radiator (30) based on at least one of a plant type of the wanted plant and a plant age of the wanted plant derived from the recognition by the plant treatment controller (40) of the wanted plant in the at least one vegetation image.

9. The multi-spectral plant treatment device (10) of claim 8,
wherein the vegetation scanner (20) includes a fluoro imager operable to generate a fluoro vegetation image; and
wherein the plant treatment controller (40) being configured to recognize the wanted plant in the at least one vegetation image includes:
the plant treatment controller (40) being configured to recognize at least one fluorescent pattern of the wanted flower in the fluoro vegetation image; and
the plant treatment controller (40) being configured to assert the recognition of the wanted plant in the at least one vegetation image based on a recognition by the plant treatment controller (40) of the at least one fluorescent pattern of the wanted flower in the fluoro vegetation image.

10. The multi-spectral plant treatment device (10) of claim 8,
wherein the vegetation scanner (20) includes a visible imager operable to generate a visible vegetation image; and
wherein the plant treatment controller (40) being configured to recognize the wanted plant in the at least one vegetation image includes:
the plant treatment controller (40) configured to recognize at least one visible characteristic of the wanted flower in the visible vegetation image; and
the plant treatment controller (40) configured to assert the recognition of the wanted plant in the at least one vegetation image based on a recognition by the plant treatment controller (40) of at least one visible characteristic of the wanted flower in the visible vegetation image.

11. The multi-spectral plant treatment device (10) of claim 8,
wherein the plant treatment controller (40) is further configured to control a hyperspectral imaging emission of the electromagnetic radiation by the electromagnetic radiator (30) for generating a hyperspectral vegetation image; and
wherein the plant treatment controller (40) being configured to recognize the wanted plant in the at least one vegetation image includes:
the plant treatment controller (40) being configured to recognize at least one hyperspectral characteristic of the wanted flower in a hyperspectral vegetation image; and
the plant treatment controller (40) being configured to assert the recognition of the wanted plant in the at least one vegetation image based on a recognition by the plant treatment controller (40) of at least one hyperspectral characteristic of the wanted flower in the hyperspectral vegetation image.

12. The multi-spectral plant treatment device (10) of claim 9,
wherein the vegetation scanner (20) further includes a visible imager operable to generate a visible vegetation image; and
wherein the plant treatment controller (40) being configured to recognize the wanted plant in the at least one vegetation image further includes:
the plant treatment controller (40) being configured to recognize at least one visible characteristic of the wanted flower in the visible vegetation image; and
the plant treatment controller (40) being configured to assert the recognition of the wanted plant in the at least one vegetation image based on the recognition by the plant treatment controller (40) of the at least one fluorescent pattern of the wanted flower in the fluoro vegetation image and based on a recognition by the plant treatment controller (40) of at least one visible characteristic of the wanted flower in the visible vegetation image.

13. The multi-spectral plant treatment device (10) of claim 9,
wherein the plant treatment controller (40) is further configured to control a hyperspectral imaging emission of the electromagnetic radiation by the electromagnetic radiator (30) for generating a hyperspectral vegetation image; and
wherein the plant treatment controller (40) being configured to recognize the wanted plant in the at least one vegetation image includes:
the plant treatment controller (40) configured to recognize at least one hyperspectral characteristic of the wanted flower in the hyperspectral vegetation image; and
the plant treatment controller (40) configured to assert the recognition of the wanted plant in the at least one vegetation image based on the recognition by the plant treatment controller (40) of the at least one fluorescent pattern of the wanted flower in the fluoro vegetation image and based on a recognition by the plant treatment controller (40) of at least one hyperspectral characteristic of the wanted flower in the hyperspectral vegetation image.

14. The multi-spectral plant treatment device (10) of claim 1,
wherein the vegetation scanner (20) includes a fluoro imager operable to generate a fluoro vegetation image;
wherein the plant treatment controller (40) is further configured to recognize at least one fluorescent pattern of the wanted flower in the fluoro vegetation image; and
wherein, subsequent the at least one of the plant protection enhancement of the wanted plant and the plant flavor enhancement of the wanted plant, the plant treatment controller (40) is further configured to evaluate the at least one of the plant protection enhancement of the wanted plant and the plant flavor enhancement of the wanted plant based on a recognition by the plant treatment controller (40) at least one fluorescent pattern of the wanted flower in the fluoro vegetation image or a failure by the plant treatment controller (40) to recognize at least one fluorescent pattern of the wanted flower in the fluoro vegetation image.

15. The multi-spectral plant treatment device (10) of claim 1,
wherein the electromagnetic radiator (30) is configured to at least one of:
emit the electromagnetic radiation at an absorption wavelength of the unwanted plant; and
emit electromagnetic radiation within an absorption wavelength band of the unwanted plant.
